(19) United States
(12) Patent Application Publication
(10) Pub. No.: US 2025/0115817 A1
(43) Pub. Date: Apr. 10, 2025

(54) PROCESS FOR CONTROLLING CO2 OVER H2S RATIO IN OIL AND GAS PROCESSING INSTALLATIONS

(71) Applicant: Saudi Arabian Oil Company, Dhahran (SA)

(72) Inventors: Milind M. Vaidya, Dhahran (SA); Sebastien A. Duval, Dhahran (SA); Feras Hamad, Dhahran (SA); Ghulam Shabbir, Dhahran (SA); Jose Choy Pernia, Dhahran (SA); Faisal D. Al-Otaibi, Dammam (SA); Ahmed W. Ameen, Dhahran (SA)

(21) Appl. No.: 18/481,669

(22) Filed: Oct. 5, 2023

(51) Int. Cl. C10L 3/10; B01D 53/14; B01D 53/22

(52) U.S. Cl. CPC C10L 3/104; B01D 53/1425; B01D 53/1462; B01D 53/1493; B01D 53/229; C10L 3/103; B01D 2252/204; B01D 2256/245; B01D 2257/304; B01D 2257/504; C10L 2290/541; C10L 2290/548

(57) ABSTRACT

Natural gas processing plants that are capable of handling sour gas can be adapted to handle large amounts of sweet gas by maintaining a low CO₂/H₂S ratio in the natural gas. Solvent mediated acid gas removal and a CO₂ permeable membrane are used to yield a concentrated, high pressure H₂S stream. The H₂S stream is added to the natural gas.

### TECHNICAL FIELD

This document relates to systems and methods for maintaining a low CO₂/H₂S ratio in a gas processing plant.

### BACKGROUND

In a gas processing plant or other facilities that come into contact with natural gas sources, corrosion is an important concern. Natural gas can include carbon dioxide (CO₂), hydrogen sulfide (H₂S), or both. Gas that includes H₂S and/or other sulfur compounds is referred to as “sour gas.” Gas where the predominant acid gas is CO₂ is referred to as “sweet gas.” Gas plants that include assets made of carbon steel can operate successfully with sour gas sources, however, these plants are not designed to handle sweet gas. Sweet gas that includes CO₂ can corrode carbon steel at faster rate than H₂S. In contrast to CO₂, H₂S mediated corrosion has a protective effect on carbon steel. CO₂ corrosion mitigation or elimination is generally more expensive than H₂S mitigation or elimination.

Oil and gas production facilities process petroleum fluids that originate from different reservoirs. These petroleum fluids have different compositions and the composition can vary even within the production period. Oil and gas production facilities can accommodate some variations. The composition of the petroleum fluids sent to the production facility can change due to tapping into newly discovered reservoirs, optimizing liquid production due to external market opportunities, or increasing content of CO₂ due to CO₂-based enhanced oil recovery. Retrofitting an existing sour gas facility to accommodate sweet gas can be prohibitively expensive.

### SUMMARY

This disclosure describes systems and methods for maintaining a low CO₂/H₂S ratio in a gas processing plant.

In some embodiments, a system for generating a concentrated H₂S stream from natural gas, the system includes an amine gas removal unit configured to receive a natural gas stream. The amine gas removal unit is further configured to remove hydrogen sulfide gas and carbon dioxide gas from a natural gas stream to yield an acid gas stream. The system includes a first compressor coupled to the amine gas removal unit and configured to compress the acid gas stream to yield a high pressure acid gas stream, and a CO₂ permeable membrane coupled to the compressor. The CO₂ permeable membrane is configured to separate the high pressure acid gas stream into a CO₂ rich stream that is enriched in CO₂ compared to the high pressure acid gas stream and an H₂S rich stream that is enriched in H₂S compared to the high pressure acid gas stream.

In some embodiments, the amine gas removal unit includes an aqueous alkylamine solution.

In some embodiments, the aqueous alkylamine solution includes at least one of monoethanolamine, diethanolamine, or methyldiethanolamine.

In some embodiments, the system includes a slug catcher configured to receive the natural gas stream and coupled to the amine gas removal unit.

In some embodiments, the system includes a sulfur recovery unit coupled to the CO₂ permeable membrane and configured to recover sulfur from the H₂S rich stream.

In some embodiments, the system includes a second compressor coupled to the CO₂ permeable membrane and configured to compress the H₂S rich stream to yield a compressed H₂S rich stream.

In some embodiments, a method of preventing CO₂, mediated corrosion in a natural gas processing plant includes providing one or more natural gas streams, removing hydrogen sulfide (H₂S) gas and carbon dioxide (CO₂) gas from the one or more natural gas streams using an acid gas removal unit to yield an acid gas stream that is enriched in H₂S gas and CO₂ gas compared to the one or more natural gas streams, passing the acid gas stream through a CO₂ permeable membrane to yield a CO₂ rich stream that is enriched in CO₂ compared to the acid gas stream and an H₂S rich stream that is enriched in H₂S compared to the acid gas stream, and adding a first portion of the H₂S rich stream to the one or more natural gas streams.

In some embodiments, removing the H₂S gas and the CO₂ gas from the one or more natural gas streams using an acid gas removal unit includes absorbing the H₂S gas and CO₂ gas using an aqueous alkylamine solution to yield a rich amine solution, and regenerating the aqueous alkylamine solution and the acid gas stream by heating the aqueous alkylamine solution.

In some embodiments, the aqueous alkylamine solution includes at least one of monoethanolamine, diethanolamine, or methyldiethanolamine.

In some embodiments, the method includes passing the one or more natural gas streams through a slug catcher before removing H₂S gas and CO₂ gas from the one or more natural gas streams.

In some embodiments, the method includes compressing the acid gas stream before passing the acid gas stream through the CO₂ permeable membrane.

In some embodiments, the method includes routing a second portion of the H₂S rich stream to a sulfur recovery unit.

In some embodiments, the method includes combining the CO₂ rich stream with the second portion of the H₂S rich stream to yield a combined stream and routing the combined stream to the sulfur recovery unit.

In some embodiments, adding a first portion of the H₂S rich stream to the one or more natural gas streams yields a spiked natural gas stream, wherein the spiked natural gas stream includes a ratio of CO₂ to H₂S from about 20 to about 2.

In some embodiments, the spiked natural gas stream includes a ratio of CO₂ to H₂S from about 5 to about 2.

In some embodiments, the spiked natural gas stream includes a ratio of CO₂ to H₂S of about 2.

The details of one or more implementations of the disclosure are set forth in the accompanying drawings and the description that follows. Other features, objects, and advantages of the disclosure will be apparent from the description and drawings, and from the claims.

### DESCRIPTION OF DRAWINGS

FIG. 1 shows an example schematic of an existing gas treatment plant that is configured to treat sour gas.

FIG. 2 shows an example schematic of a system upgraded with the addition of an AGE unit, selectively permeable membrane, or both.

FIG. 3 shows a schematic of an example gas processing system that can process sweet gas by spiking a sweet gas feed with an H₂S stream.

FIG. 4 shows a flow diagram of a method of preventing CO₂ mediated corrosion in a natural gas processing plant.

FIG. 5 shows a schematic illustration of the simulated gas treatment system 500.

Like reference symbols in the various drawings indicate like elements.

### DETAILED DESCRIPTION

Reference will now be made in detail to certain embodiments of the disclosed subject matter, examples of which are illustrated in part in the accompanying drawings. While the disclosed subject matter will be described in conjunction with the enumerated claims, it will be understood that the exemplified subject matter is not intended to limit the claims to the disclosed subject matter.

Provided in this disclosure, in part, are methods and systems to prevent CO₂ mediated corrosion by ensuring that the ratio of CO₂ to H₂S in a natural gas stream is low enough that corrosion is mediated by H₂S. The corrosion products of H₂S mediated corrosion are more protective than those of CO₂.

In a gas treatment plant where CO₂ mediated corrosion is a concern, a material selection specialist would select corrosion resistant alloys to avoid the need to manage CO₂ mediated corrosion. However, these alloys are expensive. In some embodiments, the systems and methods described herein allow for carbon steel to be used in place of the corrosion resistant alloys.

Further, reservoir management typically arranges production from different reservoirs such that the gas blend reaching a gas treatment plant would contain a CO₂/H₂S ratio in an acceptable range for a given gas treatment plant. Depending on the assets of the gas treatment plant, the acceptable range of CO₂/H₂S can vary. For example, if the gas treatment plant is designed to handle exclusively sour gas, the acceptable amount of CO₂ to H₂S may be very low. Accordingly, the gas treatment plant can have limited options for reservoir production. The systems and methods described herein allow for enhanced flexibility regarding the natural gas source and enable increasing sourness of the natural gas by recycling a stream with a high concentration of H₂S relative to CO₂.

The methods and systems described herein can also reduce the cost to enable existing plants to accommodate a higher CO₂ content in a feed gas while maintaining H₂S mediated corrosion in a safe range. For example, the methods and systems described herein can negate the need to retrofit an existing plant with CO₂ corrosion resistant alloys.

The ratio of carbon dioxide to hydrogen sulfide required in order for corrosion to be governed by hydrogen sulfide is currently unknown and can vary based on the assets in the gas production plant and the composition of the natural gas feed stream. In a typical gas production or treatment facility, the ratio of CO₂ to H₂S can vary from 500 to 2, for example from 20 to 2. In some embodiments, the ratio of CO₂ to H₂S (i.e., CO₂/H₂S) in the natural gas stream is from about 500 to about 2. In some embodiments, the ratio of CO₂ to H₂S is from about 250 to about 2. In some embodiments, the ratio of CO₂ to H₂S is from about 200 to about 2. In some embodiments, the ratio of CO₂ to H₂S is from about 150 to about 2. In some embodiments, the ratio of CO₂ to H₂S is from about 100 to about 2. In some embodiments, the ratio of CO₂ to H₂S is from about 50 to about 2. In some embodiments, the ratio of CO₂ to H₂S is from about 25 to about 2. In some embodiments, the ratio of CO₂ to H₂S is from about 20 to about 2. In some embodiments, the ratio of CO₂ to H₂S is from about 5 to about 2. In some embodiments, the ratio of CO₂ to H₂S is below 5. The appropriate ratio for a facility can be determined based on empirical or field data. The appropriate ratio for a facility can also be determined by the plant integrity engineer, asset owner policy, or local regulatory requirements. The methods and systems described herein adjust this ratio to the optimal ratio for a given facility or asset. The methods and systems described herein allow for the CO₂/H₂S ratio to meet the challenging lower goal of 2.

A low CO₂/H₂S ratio in the feed stream, for example a CO₂/H₂S ratio of about 2, requires a very high H₂S/CO₂ ratio in a spiking stream to be able to achieve the targeted ratio. In some embodiments, a solvent mediated acid gas enrichment unit and a CO₂ permeable membrane are used to generate a high H₂S/CO₂ ratio in a spiking stream. Solvent mediated acid gas enrichment (AGE) utilizes a solvent that includes an alkylamine to remove H₂S and CO₂ from a gas stream. Based on the difference in reactivity with the amine, the H₂S and CO₂ are separated. However, there is a limit to the slippage of CO₂ that avoids co-slippage of H₂S. In practice, the H₂S concentration resulting from treatment with AGE does not exceed 70%. In some embodiments, the alkylamine used in the AGE process is a tertiary amine, for example methyldiethanolamine (MDEA). In some embodiments, the alkylamine is a hindered amine such that reaction of the amine process is kinetically controlled, i.e., H₂S reacts faster and therefore CO₂ can slip the process. The hindered alkylamine can then undergo a regeneration step to liberate the H₂S.

The AGE-recovered H₂S can be regenerated and reused in the spiking stream. The maximum concentration of H₂S achievable by AGE is about 70 mol % H₂S. With a spiking stream of H₂S that is only about 70 mol % H₂S and about 30% mol CO₂, the resulting feed gas mole ratio of H₂S/CO₂ is only 2.33. Attempts to produce a stream with a higher concentration of H₂S via solvent AGE can result in a high H₂S leak from the alkylamine solution. This H₂S leak can be a toxicity and/or environmental concern and can affect the levels of SO₂ emission from a plant or facility. Given this limitation, an enormous amount of recycling of the acid gas H₂S would be required, in turn leading to a high load on the AGE unit. Accordingly, the systems and methods described herein utilize a combination of AGE and membrane separation. This combination yields a higher concentration of H₂S than AGE alone, and avoids the limitations and liability of AGE alone.

In some embodiments, the membrane units are installed to accommodate a higher demand and result in an H₂S enriched stream with a sufficiently high concentration of H₂S.

In some embodiments, the membrane is a CO₂ selective membrane. CO₂ selective membranes are advantageous over solvent AGE alone. For example, with a CO₂ selective membrane, the rejection stream is a high pressure H₂S concentrated stream, which minimizes the need for further compression of a spiking stream. In addition, the membrane rejected stream will include a decreased concentration of water, further preventing condensation and water-mediated corrosion.

In some embodiments, the H₂S rich, CO₂ poor stream is spiked directly into a feed stream of a CO₂ rich stream. This can be done at low or intermediate pressure, for example, 150 to 300 psig. At a higher pressure, to avoid condensation of H₂S and CO₂, a premixing before the final compression with a dry sales gas can be utilized.

### Systems for Generating H₂S Spiking Stream

In the present disclosure, a system for generating a concentrated hydrogen sulfide (H₂S) includes an amine gas removal unit, a first compressor, and a CO₂ permeable membrane. In some embodiments, the amine gas removal unit is configured to receive a natural gas stream and to remove hydrogen sulfide gas and carbon dioxide gas from a natural gas stream to yield an acid gas stream. In some embodiments, the first compressor is coupled to the amine gas removal unit and configured to compress the acid gas stream to yield a high pressure acid gas stream. In some embodiments, the CO₂ permeable membrane is configured to separate the high pressure acid gas stream into a CO₂ rich stream that is enriched in CO₂ compared to the high pressure acid gas stream and an H₂S rich stream that is enriched in H₂S compared to the high pressure acid gas stream.

In some embodiments, the amine gas removal unit includes an aqueous alkylamine solution. In some embodiments, the alkylamine can be a primary amine. For example, the alkylamine can have the formula RNH₂. In some embodiments, the alkylamine is monoethanolamine (MEA). In some embodiments, the alkylamine is a secondary amine. For example, the alkylamine can have the formula RR′NH. In some embodiments, the alkylamine is diethanolamine (DEA). In some embodiments, the alkylamine is a tertiary amine. For example, the alkylamine can have the formula RR′R″N. In some embodiments, the alkyl amine is methyldiethanolamine (MDEA).

In some embodiments, the system includes a slug catcher. The slug catcher is configured to receive the natural gas stream. The slug catcher is coupled to the amine gas removal unit. The natural gas stream can contain slugs, a plug of either mostly liquid or mostly gas that exits a wellhead. A slug catcher is a vessel with sufficient buffer volume to store the expected liquid or gaseous plug, and to prevent overloading the system.

In some embodiments, the system includes a sulfur recovery unit. The sulfur recovery unit is coupled to the CO₂ permeable membrane. The sulfur recovery unit is configured to recover sulfur from the H₂S rich stream.

In some embodiments, the system includes a second compressor coupled to the CO₂ permeable membrane and configured to compress the H₂S rich stream to yield a compressed H₂S rich stream.

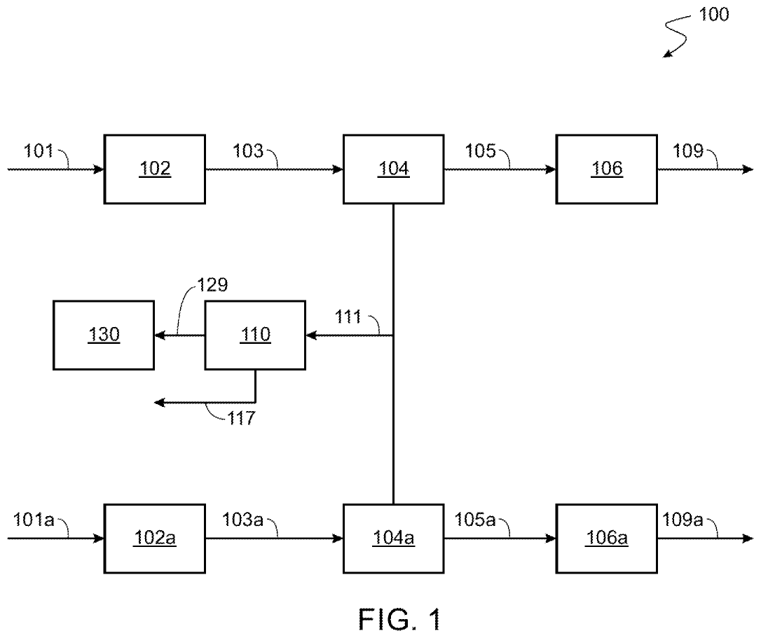

In some embodiments, an existing gas plant can be updated with a selective membrane and acid gas removal unit. FIG. 1 illustrates an example schematic of an existing gas treatment plant that is configured to treat sour gas and has not been updated as described herein. The gas treatment plant 100 treats a feed gas 101 and/or a feed gas 101a.

In some instances, the feed gas 101/101a will contain slugs, a plug of either mostly liquid or mostly gas that exits a wellhead. The feed gas 101/101a passes through a slug catcher 102/102a. The slug catcher 102/102a is configured and coupled to receive the feed gas 101/101a. The slug catcher 102/102a is a vessel with sufficient buffer volume to store the expected liquid or gaseous plug, and to prevent overloading the system. The slug catcher 1021102a is configured and coupled to pass a sour gas stream 103 to an acid gas recovery (AGR) unit 104/104a. The AGR unit 104/104a is configured to remove hydrogen sulfide and carbon dioxide from gasses. The AGR unit 104/104a includes an aqueous solution that includes an alkylamine. The alkylamine solution in the AGR absorbs H₂S and CO₂ to produce a sweet gas stream 105/105a and an amine solution rich in the absorbed gases. The rich amine solution can then be treated to regenerate a lean amine solution and an acid gas stream 111. In some embodiments, the regeneration process includes absorption in a column and regeneration by boiling the amine solution and steam stripping. The acid gas stream 111 includes H₂S and CO₂. The AGR unit 104/104a is configured and coupled to route the acid gas stream 111 to a sulfur recovery unit 110. The sulfur recovery unit 110 yields a sulfur stream 117 and a tail gas 129. The sulfur recovery unit 110 is configured and coupled to route the tail gas 129 to a tail gas treatment unit 130. In some embodiments, the tail gas treatment unit 130 is a reduction followed by an H₂S selective amine absorption.

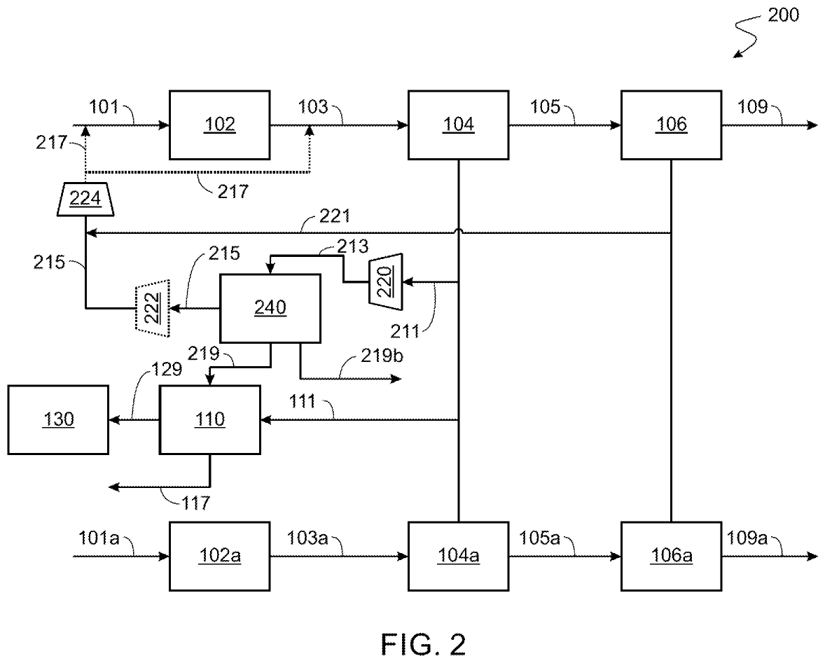

FIG. 2 shows an example schematic of the gas treatment plant 100 upgraded as described herein to a system 200, with the addition of an AGE unit, selectively permeable membrane, or both. In more detail, the system 200 can include a CO₂ selective membrane, a solvent-based AGE unit, or a combination of a CO₂ selective membrane and solvent AGE unit at location 240. System 200 is configured and coupled to send a second portion of the acid gas stream 211 to a compressor 220. At least a portion of the acid gas stream 211 is sent to the membrane, AGE unit, or combination at location 240. The membrane, AGE unit, or combination 240 is configured and coupled to send a CO₂ rich stream to the sulfur recovery unit 110. In some embodiments, the membrane, AGE unit, or combination 240 is configured and coupled to send an H₂S rich stream 215 to a compressor 222 to yield a compressed H₂S rich stream 215. In some implementations, the H₂S rich stream 215 is not compressed with the compressor 222, in order to avoid the formation of liquid H₂S, which can damage a compressor.

In some embodiments, a low pressure gas 221 from deep ethane recovery (DER), recovered from the dehydration and natural gas recovery unit 106, is combined with the H₂S rich stream 215 to yield a mixed H₂S rich stream 217. Dehydration is necessary before DER to ensure that water is present only in a few ppm. Deep ethane recovery uses an expander to cool the gas and recover the C2+ hydrocarbons at low temperature. In some embodiments, the recovered C2+, lean gas is recompressed to yield a lower pressure gas 221. In some embodiments, this low pressure gas 221 is mixed with the H₂S rich stream 215 to yield a mixed H₂S rich stream 217. In some embodiments, the mixed H₂S rich stream 217 is combined with the feed gas 101 to maintain a low CO₂/H₂S ratio. In some embodiments, the mixed H₂S rich stream 217 is combined with the sour gas stream 103. In some embodiments, the mixed H₂S rich stream 217 is injected at a well-head, trunk line, plant feed, or upstream amine plant.

The membrane, AGE unit, or combination at location 240 is also configured and coupled to produce a CO₂ rich stream 219. The CO₂ rich stream 219 can be sent to the sulfur recovery unit 110. In some embodiments, at least a portion of the CO₂ rich stream 219b is vented or made available for carbon capture, utilization and storage (CCUS).

The system shown in FIG. 2 illustrates how an existing system can be upgraded with a membrane and/or AGE unit to retrofit an existing plant to handle sweet gas. This upgrade is more cost efficient than altering all of the assets within a plant and can easily adapt to changing feed gas compositions.

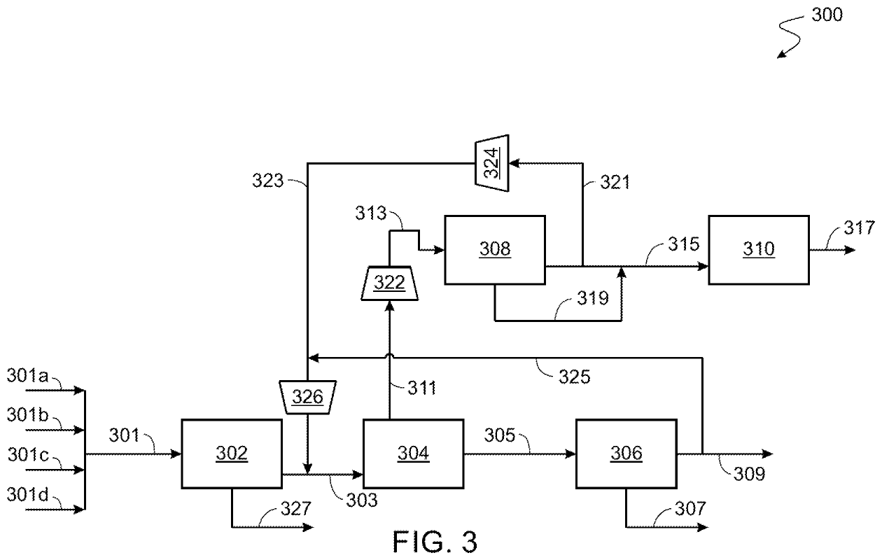

FIG. 3 is a schematic of an example gas treatment system 300 that can process sweet gas by spiking a sweet gas feed with an H₂S stream. The system includes a slug catcher 302. The slug catcher 302 is configured and coupled to receive a feed stream 301. The feed stream 301 can be a mixture of more than one stream, for example, a mixture of four well streams 301a, 301b, 301c, and 301d. Each of the four well streams 301a-d can have a different composition.

In some instances, the feed stream 301 will contain slugs, a plug of either mostly liquid or mostly gas that exits a wellhead. The slug catcher 302 is a vessel with sufficient buffer volume to store the expected liquid or gaseous plug, and to prevent overloading the system.

The system is configured and coupled to route the natural gas stream 303 is then routed to an amine gas removal (AGR) unit 304. The AGR unit 304 is configured to remove hydrogen sulfide and carbon dioxide from gasses. The AGR unit 304 includes an aqueous solution that includes an alkylamine. In some embodiments, the alkylamine can be a primary amine. For example, the alkylamine can have the formula RNH₂. In some embodiments, the alkylamine is monoethanolamine (MEA). In some embodiments, the alkylamine is a secondary amine. For example, the alkylamine can have the formula RR′NH. In some embodiments, the alkylamine is diethanolamine (DEA). In some embodiments, the alkylamine is a tertiary amine. For example, the alkylamine can have the formula RR′R″N. In some embodiments, the alkyl amine is methyldiethanolamine (MDEA).

The alkylamine solution in the AGR absorbs H₂S and CO₂ to produce a sweet gas stream 305 and an amine solution rich in the absorbed gases. The rich amine solution can then be treated to regenerate a lean amine solution and an acid gas stream 311. In some embodiments, the regeneration process includes absorption in a column and regeneration by boiling the amine solution and steam stripping. The acid gas stream 311 includes H₂S and CO₂. The AGR unit 304 is configured and coupled to route the acid gas stream 311 to a compressor 322 to yield a high pressure acid gas stream 313. The high pressure acid gas stream 313 is then routed to a CO₂ permeable membrane 308. The membrane yields a CO₂ rich stream 319 and an H₂S rich stream 321. In some embodiments, at least a portion of the H₂S rich stream 321 is sent to a sulfur recovery unit 310. Alternatively or in combination, the H₂S stream can be used to spike the natural gas stream 303, increasing the concentration of H₂S and decreasing the ratio of CO₂ to H₂S.

In simulations where the combined stream 303 is spiked with H₂S, at least a portion of the H₂S rich stream 321 can be sent to a compressor 324 to yield a compressed H₂S rich stream 323. The compressed H₂S rich stream 323 is then spiked into the natural gas stream 303.

The membrane 308 yields a CO₂ rich stream 319. The CO₂ rich stream 319 can be combined with the portion of the H₂S rich stream 315 and sent to a sulfur recovery unit 310. In the sulfur recovery unit 310, the H₂S is converted into a benign form, for example, elemental sulfur.

The AGR unit 304 also produces a sweet gas stream 305. At unit 306, the sweet gas stream 305 can be dehydrated. In some embodiments, at unit 306 the gas stream 305 is dehydrated by absorption with a glycol, for example triethylene glycol. Gycol is typically acceptable for use in sales gas pipelines, with a water content between 4-7 pounds per million standard cubic feet of gas. In some embodiments, at unit 306 the gas stream 305 is dehydrated by absorption with a molecule sieve, for example a 3A or 4A sieve. The dehydrated gas 309 can be sent to a pipeline as a sales gas. In some embodiments, a portion of the sales gas 325 is mixed with the H₂S rich stream 323.

In some embodiments, the unit 306 is only a dehydration unit and stream 307 is water. In some embodiments, the unit 306 is a dehydration and liquid recovery unit and stream 307 is natural gas liquid.

### Methods for Generating H₂S Spiking Stream

The methods include absorbing H₂S from a natural gas stream by utilizing H₂S selective amine absorption. In some embodiments, acid gas enrichment (AGE) is used to selectively absorb H₂S. AGE is an amine process that further treats the acid gas (H₂S and CO₂). H₂S reacts faster with amines than CO₂, therefore, the H₂S and CO₂ gasses are separated. However, there is a limitation to the slippage of CO₂ that also avoids co-slippage of H₂S. In practice, H₂S concentration of the recovered H₂S does not exceed 70%.

The methods include enriching a natural gas stream in hydrogen sulfide (H₂S) using selective amine absorption and a selective membrane to yield an enriched H₂S stream. In some embodiments, the methods include spiking the natural gas stream with the enriched H₂S stream. In some embodiments, the membrane is selectively permeable to CO₂, i.e., more permeable to CO₂ than to H₂S. In some embodiments, a sweet gas (i.e., where CO₂ is the predominant acid gas) is spiked with an H₂S rich gas in order to maintain a CO₂/H₂S ratio low enough that corrosion of assets will be governed by H₂S and not by CO₂.

In some embodiments, the acid gas components, H₂S and CO₂, are separated and a fraction of an H₂S enriched stream is recycled. A gas stream can be enriched with a solvent-based gas enrichment, with a CO₂ selective membrane, or a combination of both.

In some embodiments, the membrane is selectively permeable to CO₂ compared to H₂S. In the present disclosure, the combination of solvent-based gas enrichment and a CO₂ selective membrane is used to yield a stream with a very high H₂S to CO₂ ratio. This stream can then be used to spike the feed stream, i.e., can be reintroduced close to the well-head, header, or plant inlet. Accordingly, the CO₂/H₂S ratio in the feed stream can be maintained in an acceptable range to ensure H₂S mediated corrosion.

### Methods of Preventing CO₂ Mediated Corrosion

In the present disclosure, a method of preventing CO₂ mediated corrosion in a natural gas processing plant includes providing one or more natural gas streams, and removing hydrogen sulfide (H₂S) gas and carbon dioxide (CO₂) gas from the one or more natural gas streams using an acid gas removal unit to yield an acid gas stream. The acid gas stream is enriched in H₂S gas and CO₂ gas compared to the one or more natural gas streams. The acid gas stream is passed through a CO₂ permeable membrane to yield a CO₂ rich stream that is enriched in CO₂ compared to the acid gas stream and an H₂S rich stream that is enriched in H₂S compared to the acid gas stream. A first portion of the H₂S rich stream is added to the one or more natural gas streams. In some embodiments, adding a first portion of the H₂S rich stream to the one or more natural gas streams yields a spiked natural gas stream, wherein the spiked natural gas stream includes a ratio of CO₂ to H₂S from about 20 to about 2. In some embodiments, the ratio of CO₂ to H₂S in the spiked natural gas stream is from about 5 to about 2. In some embodiments, the ratio of CO₂ to H₂S in the spiked natural gas stream is about 2.

In some embodiments, removing the H₂S gas and the CO₂ gas from the one or more natural gas streams using an acid gas removal unit includes absorbing the H₂S gas and CO₂ gas using an aqueous alkylamine solution to yield a rich amine solution, and regenerating the aqueous alkylamine solution and the acid gas stream.

In some embodiments, the one or more natural gas streams are passed through a slug catcher before removing H₂S gas and CO₂ gas from the one or more natural gas streams. The natural gas stream can contain slugs, a plug of either mostly liquid or mostly gas that exits a wellhead. A slug catcher is a vessel with sufficient buffer volume to store the expected liquid or gaseous plug, and to prevent overloading the system.

In some embodiments, the acid gas stream is compressed before passing the acid gas stream through the CO₂ permeable membrane.

In some embodiments, a second portion of the H₂S rich stream is routed to a sulfur recovery unit.

In some embodiments, the CO₂ rich stream is combined with the second portion of the H₂S rich stream to yield a combined stream. The combined stream is routed to the sulfur recovery unit.

In some embodiments, a first portion of the sales gas is mixed with the H₂S rich stream.

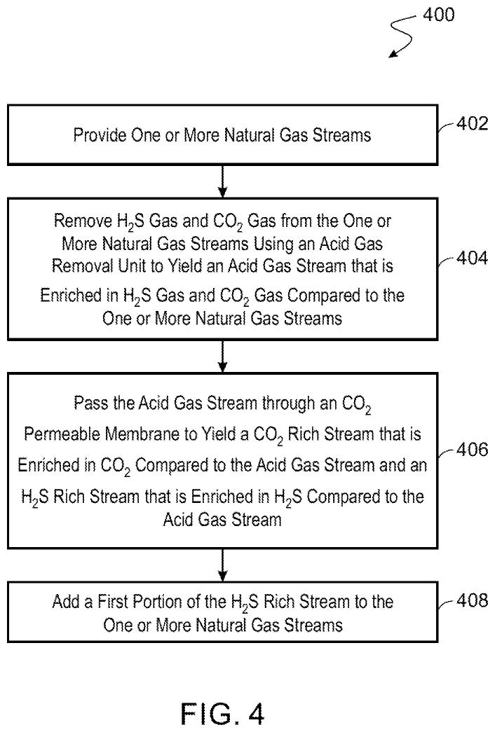

FIG. 4 shows a flowchart of a method 400 of preventing CO₂ mediated corrosion in a natural gas processing plant. At 402, one or more natural gas streams are provided. At 404, hydrogen sulfide (H₂S) gas and carbon dioxide (CO₂) gas are removed from the one or more natural gas streams using an acid gas removal unit to yield an acid gas stream. The acid gas stream is enriched in H₂S gas and CO₂ gas compared to the one or more natural gas streams. At 406, the acid gas stream is passed through a CO₂ permeable membrane to yield a CO₂ rich stream that is enriched in CO₂ compared to the acid gas stream and an H₂S rich stream that is enriched in H₂S compared to the acid gas stream. At 408, a first portion of the H₂S rich stream is added to the one or more natural gas streams.

In some embodiments, removing the H₂S gas and the CO₂ gas from the one or more natural gas streams using an acid gas removal unit includes absorbing the H₂S gas and CO₂ gas using an aqueous alkylamine solution to yield a rich amine solution, and regenerating the aqueous alkylamine solution and the acid gas stream. In some embodiments, absorbing the H₂S gas and CO₂ gas using an aqueous alkylamine solution is followed by regenerating the alkylamine with heat, which also liberates the acid gas from the amine.

In some embodiments, the one or more natural gas streams are passed through a slug catcher before removing H₂S gas and CO₂ gas from the one or more natural gas streams. The natural gas stream can contain slugs, a plug of either mostly liquid or mostly gas that exits a wellhead. A slug catcher is a vessel with sufficient buffer volume to store the expected liquid or gaseous plug, and to prevent overloading the system.

In some embodiments, the acid gas stream is compressed before passing the acid gas stream through the CO₂ permeable membrane.

In some embodiments, a second portion of the H₂S rich stream is routed to a sulfur recovery unit.

In some embodiments, the CO₂ rich stream is combined with the second portion of the H₂S rich stream to yield a combined stream. The combined stream is routed to the sulfur recovery unit.

In some embodiments, a first portion of the sales gas is mixed with the H₂S rich stream.

In some embodiments, adding a first portion of the H₂S rich stream to the one or more natural gas streams yields a spiked natural gas stream, wherein the spiked natural gas stream includes a ratio of CO₂ to H₂S from about 20 to about 2. In some embodiments, the ratio of CO₂ to H₂S in the spiked natural gas stream is from about 5 to about 2. In some embodiments, the ratio of CO₂ to H₂S in the spiked natural gas stream is about 2.

### Definitions

Unless otherwise defined, all technical and scientific terms used in this document have the same meaning as commonly understood by one of ordinary skill in the art to which the present disclosure belongs. Methods and materials are described in this document for use in the present disclosure; other, suitable methods and materials known in the art can also be used. The materials, methods, and examples are illustrative only and not intended to be limiting. All publications, patent applications, patents, sequences, database entries, and other references mentioned in this document are incorporated by reference in their entirety. In case of conflict, the present specification, including definitions, will control.

Values expressed in a range format should be interpreted in a flexible manner to include not only the numerical values explicitly recited as the limits of the range, but also to include all the individual numerical values or sub-ranges encompassed within that range as if each numerical value and sub-range is explicitly recited. For example, a range of “about 0.1% to about 5%” or “about 0.1% to 5%” should be interpreted to include not just about 0.1% to about 5%, but also the individual values (for example, 1%, 2%, 3%, and 4%) and the sub-ranges (for example, 0.1% to 0.5%, 1.10% to 2.2%, and 3.3% to 4.4%) within the indicated range. The statement “about X to Y” has the same meaning as “about X to about Y,” unless indicated otherwise. Likewise, the statement “about X, Y, or about Z” has the same meaning as “about X, about Y, or about Z,” unless indicated otherwise.

The term “about,” as used in this disclosure, can allow for a degree of variability in a value or range, for example, within 10%, within 5%, or within 1% of a stated value or of a stated limit of a range.

As used in this disclosure, the terms “a,” “an,” and “the” are used to include one or more than one unless the context clearly dictates otherwise. The term “or” is used to refer to a nonexclusive “or” unless otherwise indicated. The statement “at least one of A and B” has the same meaning as “A, B. or A and B.” In addition, it is to be understood that the phraseology or terminology employed in this disclosure, and not otherwise defined, is for the purpose of description only and not of limitation. Any use of section headings is intended to aid reading of the document and is not to be interpreted as limiting; information that is relevant to a section heading may occur within or outside of that particular section.

In the methods described in this disclosure, the acts can be carried out in any order, except when a temporal or operational sequence is explicitly recited. Furthermore, specified acts can be carried out concurrently unless explicit claim language recites that they be carried out separately. For example, a claimed act of doing X and a claimed act of doing Y can be conducted simultaneously within a single operation, and the resulting process will fall within the literal scope of the claimed process.

The terms “sour” or “sour gas” mean that the gas stream contains hydrogen sulfide (H₂S). The terms “sweet” or “sweet gas” mean that the gas contains little or no hydrogen sulfide (H₂S).

As used in this disclosure, a “sales gas” is the processed natural gas stream that can be safely sent to an end user. Sales gas includes methane, ethane, and traces of heavier hydrocarbons.

As used in this disclosure, “configured to” indicates that the feature is arranged and inherently capable of performing the recited function.

As used in this disclosure, a feature “coupled to receive” a second feature indicates that the feature is capable of receiving a second feature. As used in this disclosure, a feature “coupled to combine” a two or more features indicates that the feature is capable of combining the two or more features. As used in this disclosure, a feature “configured to separate” a second feature indicates that the feature is capable of separating the second feature.

As used in this disclosure, “weight percent” (wt %) can be considered a mass fraction or a mass ratio of a substance to the total mixture or composition. Weight percent can be a weight-to-weight ratio or mass-to-mass ratio, unless indicated otherwise.

As used in this disclosure, “mole percent” (mol %) can be considered a mole fraction or a mole ratio of a substance to the total mixture of composition.

As used in this disclosure, a “pound mol” (1 lbm-mol) is equal to 453.592 mole.

### EXAMPLES

### Example 1: Classical Solvent AGE Process

As described herein, in a classical solvent AGE process, the enrichment in H₂S can lead to a concentration of H₂S up to about 70 mol %. A 70 mol % H₂S may be sufficient to reduce the ratio of CO₂/H₂S to about 10 but will be insufficient for a CO₂/H₂S ratio of 2.

However, an H₂S concentration of about 90 mol % can be achieved by using a CO₂ selective membrane alone or in combination with solvent based AGE. With a highly concentrated H₂S stream, a small spiking flowrate can achieve the required CO₂/H₂S ratio to ensure H₂S mediated corrosion. Table 1 shows the ratio of H₂S/CO₂ in an enriched acid gas as a function of the H₂S mol % in an enriched gas stream.

TABLE 1
Ratio of H₂S/CO₂ versus H₂S in the enriched gas

| | | | Mole |
|---|---|---|---|
| | H₂S | CO₂ | Ratio of |
| Enrichment Process | (mol %) | (mol %) | H₂S/CO₂ |
| Solvent or membrane AGE | 20 | 80 | 0.25 |
| Solvent or membrane AGE | 30 | 70 | 0.43 |
| Solvent or membrane AGE | 40 | 60 | 0.67 |
| Solvent or membrane AGE | 46 | 54 | 0.85 |
| Solvent or membrane AGE | 52 | 48 | 1.08 |
| Solvent or membrane AGE | 55 | 45 | 1.22 |
| Solvent or membrane AGE | 58 | 42 | 1.38 |
| Solvent or membrane AGE | 60 | 40 | 1.50 |
| Solvent or membrane AGE | 62 | 38 | 1.63 |
| Solvent or membrane AGE | 63.5 | 36.5 | 1.74 |
| Solvent or membrane AGE | 65.5 | 34.5 | 1.90 |
| Solvent or membrane AGE | 67 | 33 | 2.03 |
| Solvent or membrane AGE | 68 | 32 | 2.13 |
| Membrane AGE (with or | 70 | 30 | 2.33 |
| without solvent AGE) | | | |
| Membrane AGE (with or | 75 | 25 | 3.00 |
| without solvent AGE) | | | |
| Membrane AGE (with or | 80 | 20 | 4.00 |
| without solvent AGE) | | | |
| Membrane AGE (with or | 85 | 15 | 5.67 |
| without solvent AGE) | | | |
| Membrane AGE (with or | 90 | 10 | 9.00 |
| without solvent AGE) | | | |
| Membrane AGE (with or | 95 | 5 | 19.00 |
| without solvent AGE) | | | |

### Example 2: Simulated Sweet Gas Treatment System

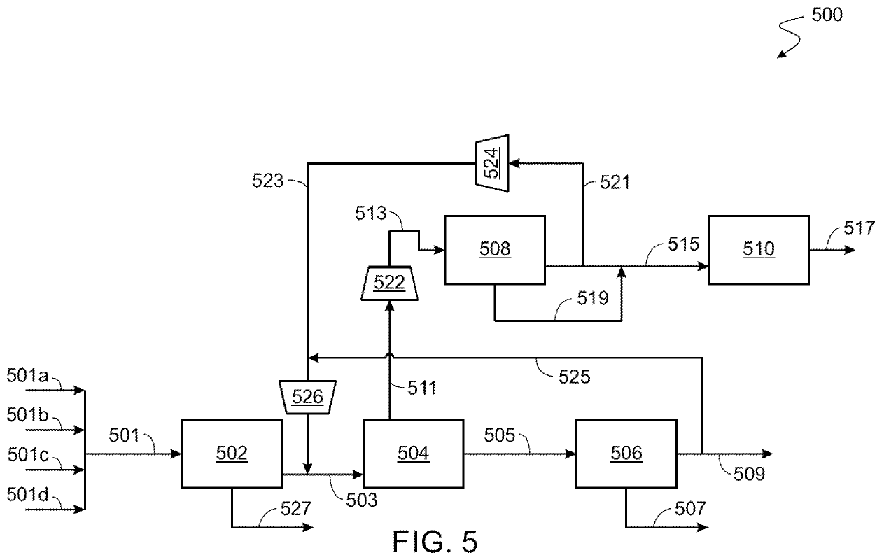

A simulation of a gas treatment system 500 was run to illustrate how a gas treatment plant with a CO₂ permeable membrane and an AGE system can alter the ratio of CO₂ to H₂S in a sweet gas feed by spiking the sweet gas feed with recycled H₂S. FIG. 5 shows a schematic illustration of the simulated gas treatment system 500. The simulated gas treatment system 500 included a slug catcher 502. The slug catcher was configured and coupled to receive a feed stream 501. Simulated streams were given reference numbers as described herein and shown in Tables 2-3. The feed stream 501 was simulated as a mixture of more than one stream, for example, a mixture of four well streams (501a. 501b, 501c, and 501d). Each of the four well streams 501a-d were simulated to have a different composition.

The system was configured and coupled to route the feed stream through the slug catcher to yield a natural gas stream 503. The natural gas stream 503 was then routed to an amine gas removal (AGR) unit 504. The AGR unit was configured to remove hydrogen sulfide and carbon dioxide from gasses. The AGR unit included an aqueous solution that included an alkylamine. The alkylamine solution in the AGR absorbed H₂S and CO₂ and produced a sweet gas stream 505 and an amine solution rich in the absorbed gases. The rich amine solution was treated to regenerate a lean amine solution and an acid gas stream 511. The rich amine solution was assumed to be fully regenerated, as can be achieved with heat. In the simulation software, the regeneration of the amine is simulated by a split of the amine and the acid gas stream. The acid gas stream was set at a low pressure as would be experienced in a real-world amine unit. The acid gas stream 511 included H₂S and CO₂. The AGR unit was configured and coupled to route the acid gas stream 511 to a compressor 522 to yield a high pressure acid gas stream 513. The high pressure acid gas stream 513 was then routed to a CO₂ permeable membrane 508. The membrane yielded a CO₂ rich stream 519 and an H₂S rich stream 521. In some simulations, at least a portion of the H₂S stream 515 was sent to a sulfur recovery unit 510. Alternatively or in combination, the H₂S stream 515 can be used to spike the natural gas stream 503, increasing the concentration of H₂S and decreasing the ratio of CO₂ to H₂S.

In simulations where the combined stream 503 is spiked with H₂S, at least a portion of the H₂S rich stream 521 was sent to a compressor 526 to yield a compressed H₂S rich stream 523. The compressed H₂S rich stream 523 was then spiked into the natural gas stream 503.

The CO₂ permeable membrane 508 also yielded a CO₂ rich stream 519. The CO₂ rich stream 519 was combined with a portion of the H₂S rich stream 515 and sent to a sulfur recovery unit 510.

The AGR unit 504 also produced a sweet gas stream 505. The simulated system also included a dehydration unit 506 where the sweet gas stream 505 was dehydrated. The simulation dehydrates the sweet gas stream, for example by simulating absorption with glycol or dehydration with a molecular sieve. The dehydrated gas 509 was sent to a pipeline as a sales gas. In some simulations, a portion of the sales gas 525 is mixed with the H₂S rich stream 523.

The simulations were conducted with PRO II from AVEVA. The software performs heat and material balance calculations based on a build process model. In a first simulation, the plant was designed to treat sour gas from a reservoir with a composition similar to the stream from well stream 501a. In a situation where a source reservoir is depleted and a new sweet field is introduced, the CO₂/H₂S ratio will change. If the ratio of CO₂/H₂S increases above 2, CO₂ mediated corrosion can become an issue. Table 2 shows an example simulation of the simulated system in which the natural gas stream 503 was not spiked with H₂S rich stream 523. Table 3 shows an example simulation of the same simulated system in which the natural gas stream 503 was spiked with the high pressure H₂S stream 523.

TABLE 2
Simulation gas treatment system, without H₂S spike

| Stream Reference No. | 501a | 501b | 501a + b | 501c | 501d | 501c + d | 527 | 503 | 505 | 511 |
|---|---|---|---|---|---|---|---|---|---|---|
| Stream Description | Feed | Feed | Feed | Feed | Feed | Feed | Sour | Combined | Sweet | Acid Gas |
| | | | | | | | condensate | Stream | Gas | |
| Phase | Mixed | Mixed | Mixed | Mixed | Vapor | Mixed | Liquid | Vapor | Vapor | Vapor |
| Temperature (° F.) | 120 | 120 | 118.8 | 120 | 120 | 118.8 | 120 | 120 | 124.8 | 124.8 |
| Pressure (PSIA) | 900 | 900 | 900 | 900 | 900 | 900 | 900 | 900 | 900 | 0.05 |
| Flowrate (Lb-mol/h) | 7500 | 2500 | 10000 | 6500 | 3500 | 10000 | 1031.623 | 18968.38 | 17633.76 | 1334.618 |
| Composition | | | | | | | | | | |
| C1 | 0.690 | 0.700 | 0.693 | 0.700 | 0.720 | 0.707 | 0.206 | 0.727 | 0.781 | 0.005 |
| C2 | 0.050 | 0.060 | 0.053 | 0.060 | 0.030 | 0.050 | 0.050 | 0.051 | 0.055 | 0.000 |
| C3 | 0.020 | 0.045 | 0.026 | 0.045 | 0.020 | 0.036 | 0.064 | 0.029 | 0.032 | 0.000 |
| IC4 | 0.005 | 0.020 | 0.009 | 0.020 | 0.010 | 0.017 | 0.044 | 0.011 | 0.012 | 0.000 |
| NCA | 0.010 | 0.020 | 0.013 | 0.020 | 0.010 | 0.017 | 0.061 | 0.012 | 0.013 | 0.000 |
| IC5 | 0.005 | 0.015 | 0.008 | 0.015 | 0.010 | 0.013 | 0.068 | 0.007 | 0.008 | 0.000 |
| NO5 | 0.005 | 0.030 | 0.011 | 0.030 | 0.010 | 0.023 | 0.125 | 0.011 | 0.012 | 0.000 |
| NC6 | 0.025 | 0.040 | 0.029 | 0.040 | 0.010 | 0.030 | 0.324 | 0.013 | 0.014 | 0.000 |
| H2S | 0.030 | 0.000 | 0.023 | 0.000 | 0.050 | 0.018 | 0.022 | 0.020 | 0.000 | 0.281 |
| CO2 | 0.060 | 0.040 | 0.055 | 0.040 | 0.050 | 0.044 | 0.027 | 0.050 | 0.000 | 0.713 |
| N2 | 0.100 | 0.030 | 0.083 | 0.030 | 0.080 | 0.048 | 0.009 | 0.068 | 0.073 | 0.000 |
| Stream Reference No. | 513 | 519 | 521 | 523 | 515 | 507 | 509 | 525 | | |
| Stream | High | CO2 Rich | H2S Rich | High | SRU Feed | Natural | Sales Gas | CO2 | | |
| Description | Pressure | | | Pressure | Stream | Gas | | mixing | | |
| | Acid Gas | | | H2S | | Stream | | | | |
| | | | | Stream | | | | | | |
| Phase | Vapor | Vapor | Vapor | n/a | Vapor | Vapor | Vapor | Vapor | | |
| Temperature (° F.) | 100 | 87.1 | 87.1 | n/a | 80.6 | 100.7 | 100.7 | 100.7 | | |
| Pressure (PSIA) | 170 | 29 | 170 | n/a | 29 | 0.05 | 900 | 900 | | |
| Flowrate (Lb-mol/h) | 1334.618 | 970.522 | 364.0961 | 0 | 1334.618 | 2035.751 | 15598.01 | 0 | | |
| Composition | | | | | | | | | | |
| C1 | 0.005 | 0.002 | 0.015 | n/a | 0.005 | 0.004 | 0.883 | n/a | | |
| C2 | 0.000 | 0.000 | 0.000 | n/a | 0.000 | 0.212 | 0.034 | n/a | | |
| C3 | 0.000 | 0.000 | 0.000 | n/a | 0.000 | 0.274 | 0.000 | n/a | | |
| IC4 | 0.000 | 0.000 | 0.000 | n/a | 0.000 | 0.101 | 0.000 | n/a | | |
| NC4 | 0.000 | 0.000 | 0.000 | n/a | 0.000 | 0.111 | 0.000 | n/a | | |
| IC5 | 0.000 | 0.000 | 0.000 | n/a | 0.000 | 0.067 | 0.000 | n/a | | |
| NC5 | 0.000 | 0.000 | 0.000 | n/a | 0.000 | 0.105 | 0.000 | n/a | | |
| NC6 | 0.000 | 0.000 | 0.000 | n/a | 0.000 | 0.122 | 0.000 | n/a | | |
| H2S | 0.281 | 0.091 | 0.788 | n/a | 0.281 | 0.000 | 0.000 | n/a | | |
| CO2 | 0.713 | 0.907 | 0.196 | n/a | 0.713 | 0.000 | 0.000 | n/a | | |
| N2 | 0.000 | 0.000 | 0.000 | n/a | 0.000 | 0.000 | 0.083 | n/a | | |

TABLE 3
Simulation of gas treatment system, with H₂S spike

| Stream Reference No. | 501a | 501b | 501a + b | 501c | 501d | 501c + d | 527 | 503 | 505 | 511 |
|---|---|---|---|---|---|---|---|---|---|---|
| Stream Description | Feed | Feed | Feed | Feed | Feed | Feed | Sour | Combined | Sweet | Acid Gas |
| | | | | | | | condensate | Stream | Gas | |
| Phase | Mixed | Mixed | Mixed | Mixed | Vapor | Mixed | Liquid | Vapor | Vapor | Vapor |
| Temperature (° F.) | 120 | 120 | 118.8 | 120 | 120 | 118.8 | 120 | 130 | 124.0 | 123.0 |
| Pressure (PSIA) | 900 | 900 | 900 | 900 | 900 | 900 | 900 | 900 | 900 | 0.05 |
| Flowrate (Lb-mol/h) | 7500 | 2500 | 10000 | 6500 | 3500 | 10000 | 1024.883 | 19352.2 | 17756.83 | 1595.369 |
| Composition | | | | | | | | | | |
| C1 | 0.690 | 0.700 | 0.693 | 0.700 | 0.720 | 0.707 | 0.204 | 0.717 | 0.781 | 0.005 |
| C2 | 0.050 | 0.060 | 0.053 | 0.060 | 0.030 | 0.050 | 0.049 | 0.050 | 0.055 | 0.000 |
| C3 | 0.020 | 0.045 | 0.026 | 0.045 | 0.020 | 0.036 | 0.062 | 0.029 | 0.032 | 0.000 |
| IC4 | 0.005 | 0.020 | 0.009 | 0.020 | 0.010 | 0.017 | 0.044 | 0.011 | 0.012 | 0.000 |
| NC4 | 0.010 | 0.020 | 0.013 | 0.020 | 0.010 | 0.017 | 0.060 | 0.012 | 0.013 | 0.000 |
| ICS | 0.005 | 0.015 | 0.008 | 0.015 | 0.010 | 0.013 | 0.067 | 0.070 | 0.008 | 0.000 |
| NOS | 0.005 | 0.030 | 0.011 | 0.030 | 0.010 | 0.023 | 0.123 | 0.011 | 0.012 | 0.000 |
| NC6 | 0.025 | 0.040 | 0.029 | 0.040 | 0.010 | 0.030 | 0.322 | 0.013 | 0.014 | 0.000 |
| H2S | 0.030 | 0.000 | 0.023 | 0.000 | 0.050 | 0.018 | 0.032 | 0.029 | 0.000 | 0.353 |
| CO2 | 0.060 | 0.040 | 0.055 | 0.040 | 0.050 | 0.044 | 0.028 | 0.053 | 0.000 | 0.642 |
| N2 | 0.100 | 0.030 | 0.083 | 0.030 | 0.080 | 0.048 | 0.009 | 0.067 | 0.073 | 0.000 |
| Stream Reference No. | 513 | 519 | 521 | 523 | 515 | 507 | 509 | 525 | | |
| Stream Description | High | CO2 | H2S | High | SRU Feed | Natural | Sales Gas | Sales gas | | |
| | Pressure | Rich | Rich | Pressure | Stream | Gas | | recycled | | |
| | Acid Gas | | | H2S | | Stream | | | | |
| | | | | Stream | | | | | | |
| Phase | Vapor | Vapor | Vapor | Vapor | Vapor | Vapor | Vapor | Vapor | | |
| Temperature (° F.) | 100 | 89.67 | 89.6 | 120 | 83.1 | 99.5 | 99.5 | 99.5 | | |
| Pressure (PSIA) | 170 | 29 | 170 | 900 | 29 | 0.05 | 900 | 900 | | |
| Flowrate (Lb-mol/h) | 1595.369 | 940.397 | 654.9725 | 377.134 | 1318.325 | 2050.451 | 15706.38 | 100 | | |
| Composition | | | | | | | | | | |
| C1 | 0.005 | 0.001 | 0.009 | 0.241 | 0.004 | 0.004 | 0.883 | 0.883 | | |
| C2 | 0.000 | 0.000 | 0.000 | 0.009 | 0.000 | 0.210 | 0.034 | 0.034 | | |
| C3 | 0.000 | 0.000 | 0.000 | 0.000 | 0.000 | 0.273 | 0.000 | 0.000 | | |
| IC4 | 0.000 | 0.000 | 0.000 | 0.000 | 0.000 | 0.101 | 0.000 | 0.000 | | |
| NC4 | 0.000 | 0.000 | 0.000 | 0.000 | 0.000 | 0.111 | 0.000 | 0.000 | | |
| ICS | 0.000 | 0.000 | 0.000 | 0.000 | 0.000 | 0.068 | 0.000 | 0.000 | | |
| NC5 | 0.000 | 0.000 | 0.000 | 0.000 | 0.000 | 0.105 | 0.000 | 0.000 | | |
| NC6 | 0.000 | 0.000 | 0.000 | 0.000 | 0.000 | 0.123 | 0.000 | 0.000 | | |
| H2S | 0.353 | 0.097 | 0.722 | 0.530 | 0.276 | 0.002 | 0.000 | 0.000 | | |
| CO2 | 0.642 | 0.902 | 0.269 | 0.197 | 0.721 | 0.003 | 0.000 | 0.000 | | |
| N2 | 0.000 | 0.000 | 0.000 | 0.022 | 0.000 | 0.000 | 0.083 | 0.083 | | |

In Table 2, the CO₂/H₂S ratio in combined stream 503 is 2.5. Accordingly, without spiking the feed stream, this system is unable to reach a target CO₂/H₂S ratio of 2 or less.

As shown in Table 3, spiking the combined stream 503 with a high pressure H₂S stream 523 results in a ratio of CO₂/H₂S of 1.8. In this simulation, the high content of H₂S ensures that the corrosion is governed by H₂S rather than CO₂

### Example 3: Simulated Sweet and Sour Gas Treatment System

Table 4 shows an example simulation, using the same simulated system as Example 2. In this simulation, a natural gas processing plant is operating a combination of sweet and sour service. In this simulation, the target CO₂/H₂S ratio is below 5. Table 4 shows an example simulation without spiking the combined gas stream 503 with H₂S. In the simulation without spiking, the ratio of in the combined stream 503 CO₂/H₂S is 7.5.

Table 5 shows an example of the same simulation with H₂S spiking. In this simulation, the CO₂/H₂S ratio in the combined stream 503 is 4. Accordingly, by spiking a combined stream 503 with H₂S, a system can be configured to reduce the CO₂/H₂S ratio and allow production to continue under what would otherwise be unfavorable circumstances.

TABLE 4
Simulation of gas treatment system, without H₂S spike

| | Stream Reference No. | | | | | | | | | |
|---|---|---|---|---|---|---|---|---|---|---|
| | 501a | 501b | 501a + b | 501c | 501d | 501c + d | 527 | 503 | 505 | 511 |
| Stream | Feed | Feed | Feed | Feed | Feed | Feed | Sour | Combined | Sweet | Acid Gas |
| Description | | | | | | | condensate | Stream | Gas | |
| Phase | Mixed | Mixed | Mixed | Mixed | Vapor | Mixed | Liquid | Vapor | Vapor | Vapor |
| Temperature | 120 | 130 | 119.1402 | 120 | 120 | 119.6441 | 120 | 120 | 136.5214 | 126.5214 |
| (° F.) | | | | | | | | | | |
| Pressure | 900 | 900 | 900 | 900 | 900 | 900 | 900 | 900 | 900 | 0.05 |
| (PSIA) | | | | | | | | | | |
| Flowrate | 2500 | 7500 | 10000 | 9000 | 1000 | 10000 | 1888.306 | 18111.69 | 17182.06 | 929.6322 |
| (Lb-mol/h) | | | | | | | | | | |
| Composition | | | | | | | | | | |
| C1 | 0.690 | 0.700 | 0.698 | 0.700 | 0.720 | 0.702 | 0.218 | 0.750 | 0.790 | 0.008 |
| C2 | 0.050 | 0.060 | 0.058 | 0.060 | 0.030 | 0.057 | 0.056 | 0.057 | 0.060 | 0.000 |
| C3 | 0.020 | 0.045 | 0.039 | 0.045 | 0.020 | 0.043 | 0.078 | 0.037 | 0.039 | 0.000 |
| IC4 | 0.005 | 0.020 | 0.016 | 0.020 | 0.010 | 0.019 | 0.055 | 0.014 | 0.014 | 0.000 |
| NC4 | 0.010 | 0.020 | 0.018 | 0.020 | 0.010 | 0.019 | 0.066 | 0.013 | 0.014 | 0.000 |
| ICS | 0.005 | 0.015 | 0.013 | 0.015 | 0.010 | 0.015 | 0.069 | 0.008 | 0.008 | 0.000 |
| NOS | 0.005 | 0.030 | 0.024 | 0.030 | 0.010 | 0.028 | 0.144 | 0.014 | 0.014 | 0.000 |
| NC6 | 0.025 | 0.040 | 0.036 | 0.040 | 0.010 | 0.037 | 0.276 | 0.012 | 0.012 | 0.000 |
| H2S | 0.030 | 0.000 | 0.008 | 0.000 | 0.050 | 0.005 | 0.007 | 0.006 | 0.000 | 0.120 |
| CO2 | 0.060 | 0.040 | 0.045 | 0.040 | 0.050 | 0.041 | 0.024 | 0.045 | 0.000 | 0.872 |
| N2 | 0.100 | 0.030 | 0.048 | 0.030 | 0.080 | 0.035 | 0.006 | 0.045 | 0.047 | 0.000 |
| | Stream Reference No. | | | | | | | | | |
| | 513 | 519 | 521 | 523 | 515 | 507 | 509 | 525 | | |
| Stream | High | CO2 | H2S | High | SRU | Natural | Sales Gas | Sales gas | | |
| Description | Pressure | Rich | Rich | Pressure | Feed | Gas | | recycled | | |
| | Acid Gas | | | H2S | Stream | Stream | | | | |
| | | | | Stream | | | | | | |
| Phase | Vapor | Vapor | Vapor | n/a | Vapor | Vapor | Vapor | Vapor | | |
| Temperature | 100 | 82.0 | 82.0 | n/a | 81.3 | 99.9 | 99.9 | 99.9 | | |
| (° F.) | | | | | | | | | | |
| Pressure | 170 | 29 | 170 | n/a | 29 | 0.05 | 900 | 900 | | |
| (PSIA) | | | | | | | | | | |
| Flowrate | 929.6322 | 904.0848 | 25.54741 | 0 | 929.6322 | 2235.226 | 14946.83 | 0 | | |
| (Lb-mol/h) | | | | | | | | | | |
| Composition | | | | | | | | | | |
| C1 | 0.008 | 0.006 | 0.061 | n/a | 0.008 | 0.004 | 0.908 | n/a | | |
| C2 | 0.000 | 0.000 | 0.001 | n/a | 0.000 | 0.213 | 0.038 | n/a | | |
| C3 | 0.000 | 0.000 | 0.001 | n/a | 0.000 | 0.297 | 0.000 | n/a | | |
| IC4 | 0.000 | 0.000 | 0.001 | n/a | 0.000 | 0.111 | 0.000 | n/a | | |
| NC4 | 0.000 | 0.000 | 0.001 | n/a | 0.000 | 0.107 | 0.000 | n/a | | |
| ICS | 0.000 | 0.000 | 0.000 | n/a | 0.000 | 0.062 | 0.000 | n/a | | |
| NOS | 0.000 | 0.000 | 0.001 | n/a | 0.000 | 0.109 | 0.000 | n/a | | |
| NC6 | 0.000 | 0.000 | 0.000 | n/a | 0.000 | 0.094 | 0.000 | n/a | | |
| H2S | 0.120 | 0.097 | 0.921 | n/a | 0.120 | 0.000 | 0.000 | n/a | | |
| CO2 | 0.872 | 0.896 | 0.013 | n/a | 0.872 | 0.000 | 0.000 | n/a | | |
| N2 | 0.000 | 0.000 | 0.000 | n/a | 0.000 | 0.000 | 0.054 | n/a | | |

TABLE 5
Simulation of gas treatment system, with H₂S spike

| | Stream Reference No. | | | | | | | | | |
|---|---|---|---|---|---|---|---|---|---|---|
| | 501a | 501b | 501a + b | 501c | 501d | 501c + d | 527 | 503 | 505 | 511 |
| Stream | Feed | Feed | Feed | Feed | Feed | Feed | Sour | Combined | Sweet | Acid |
| Description | | | | | | | condensate | Stream | Gas | Gas |
| Phase | Mixed | Mixed | Mixed | Mixed | Vapor | Mixed | Liquid | Vapor | Vapor | Vapor |
| Temperature | 130 | 120 | 119.1 | 120 | 120 | 119.6 | 120 | 120 | 126.1 | 126.1 |
| (° F.) | | | | | | | | | | |
| Pressure | 900 | 900 | 900 | 900 | 900 | 900 | 900 | 900 | 900 | 0.05 |
| (PSIA) | | | | | | | | | | |
| Flowrate | 2500 | 7500 | 10000 | 9000 | 1000 | 10000 | 1884.669 | 18325.22 | 17299.89 | 1025.329 |
| (Lb-mol/h) | | | | | | | | | | |
| Composition | | | | | | | | | | |
| C1 | 0.690 | 0.700 | 0.698 | 0.700 | 0.720 | 0.702 | 0.217 | 0.747 | 0.790 | 0.007 |
| C2 | 0.050 | 0.060 | 0.058 | 0.060 | 0.030 | 0.057 | 0.056 | 0.057 | 0.060 | 0.000 |
| C3 | 0.020 | 0.045 | 0.039 | 0.045 | 0.020 | 0.043 | 0.077 | 0.036 | 0.039 | 0.000 |
| IC4 | 0.005 | 0.020 | 0.016 | 0.020 | 0.010 | 0.019 | 0.054 | 0.014 | 0.014 | 0.000 |
| NC4 | 0.010 | 0.020 | 0.018 | 0.020 | 0.010 | 0.019 | 0.065 | 0.013 | 0.014 | 0.000 |
| ICS | 0.005 | 0.015 | 0.013 | 0.015 | 0.010 | 0.015 | 0.069 | 0.008 | 0.008 | 0.000 |
| NOS | 0.005 | 0.030 | 0.024 | 0.030 | 0.010 | 0.028 | 0.144 | 0.013 | 0.014 | 0.000 |
| NC6 | 0.025 | 0.040 | 0.036 | 0.040 | 0.010 | 0.037 | 0.275 | 0.012 | 0.012 | 0.000 |
| H2S | 0.030 | 0.000 | 0.008 | 0.000 | 0.050 | 0.005 | 0.012 | 0.011 | 0.000 | 0.196 |
| CO2 | 0.060 | 0.040 | 0.045 | 0.040 | 0.050 | 0.041 | 0.024 | 0.045 | 0.000 | 0.796 |
| N2 | 0.100 | 0.030 | 0.048 | 0.030 | 0.080 | 0.035 | 0.006 | 0.045 | 0.047 | 0.000 |
| | Stream Reference No. | | | | | | | | | |
| | 513 | 519 | 521 | 523 | 515 | 507 | 509 | 525 | | |
| Stream | High | CO2 Rich | H2S Rich | High | SRU Feed | Natural | Sales Gas | Sales gas | | |
| Description | Pressure | | | Pressure | Stream | Gas | | recycled | | |
| | Acid Gas | | | H2S | | Stream | | | | |
| | | | | Stream | | | | | | |
| Phase | Vapor | Vapor | Vapor | Vapor | Vapor | Vapor | Vapor | Vapor | | |
| Temperature | 100 | 83.96379 | 83.96379 | 120 | 83.66508 | 99.41004 | 99.41004 | 99.41004 | | |
| (° F.) | | | | | | | | | | |
| Pressure | 170 | 29 | 170 | 900 | 29 | 0.05 | 900 | 900 | | |
| (PSIA) | | | | | | | | | | |
| Flowrate | 1025.329 | 904.4529 | 120.8758 | 209.884 | 915.4447 | 2245.081 | 15054.81 | 100 | | |
| (Lb-mol/h) | | | | | | | | | | |
| Composition | | | | | | | | | | |
| C1 | 0.007 | 0.004 | 0.034 | 0.450 | 0.004 | 0.004 | 0.908 | 0.908 | | |
| C2 | 0.000 | 0.000 | 0.000 | 0.018 | 0.000 | 0.212 | 0.038 | 0.038 | | |
| C3 | 0.000 | 0.000 | 0.000 | 0.000 | 0.000 | 0.296 | 0.000 | 0.000 | | |
| IC4 | 0.000 | 0.000 | 0.000 | 0.000 | 0.000 | 0.111 | 0.000 | 0.000 | | |
| NC4 | 0.000 | 0.000 | 0.000 | 0.000 | 0.000 | 0.107 | 0.000 | 0.000 | | |
| ICS | 0.000 | 0.000 | 0.000 | 0.000 | 0.000 | 0.062 | 0.000 | 0.000 | | |
| NCS | 0.000 | 0.000 | 0.000 | 0.000 | 0.000 | 0.110 | 0.000 | 0.000 | | |
| NC6 | 0.000 | 0.000 | 0.000 | 0.000 | 0.000 | 0.095 | 0.000 | 0.000 | | |
| H2S | 0.196 | 0.101 | 0.910 | 0.476 | 0.111 | 0.000 | 0.000 | 0.000 | | |
| CO2 | 0.796 | 0.895 | 0.055 | 0.029 | 0.885 | 0.000 | 0.000 | 0.000 | | |
| N2 | 0.000 | 0.000 | 0.000 | 0.026 | 0.000 | 0.000 | 0.054 | 0.054 | | |

As shown in the example simulations, spiking a feed gas with H₂S recovered from the feed gas itself can avoid the need to replace carbon steel parts by corrosion resistant alloy parts in a gas plant, by avoiding CO₂ mediated corrosion in favor of H₂S mediated corrosion. The H₂S corrosion products can protect the assets of the gas plant. In addition, the amount, timing, and concentration of the H₂S added to the combined stream can be controlled based on the composition of the combined stream. This allows a gas plant to adapt to changing natural gas sources and compositions in real time, without the need for replacing major assets.

### Embodiments

Certain embodiments of the present disclosure are provided as follows.

Embodiment 1. A system for generating a concentrated H₂S stream from natural gas, the system comprising:
an amine gas removal unit configured to receive a natural gas stream, wherein the amine gas removal unit is further configured to remove hydrogen sulfide gas and carbon dioxide gas from a natural gas stream to yield an acid gas stream;
a first compressor coupled to the amine gas removal unit and configured to compress the acid gas stream to yield a high pressure acid gas stream; and
a CO₂ permeable membrane coupled to the compressor, wherein the CO₂ permeable membrane is configured to separate the high pressure acid gas stream into a CO₂ rich stream that is enriched in CO₂ compared to the high pressure acid gas stream and an H₂S rich stream that is enriched in H₂S compared to the high pressure acid gas stream.

Embodiment 2. The system of embodiment 1, wherein the amine gas removal unit comprises an aqueous alkylamine solution.

Embodiment 3. The system of embodiment 2, wherein the aqueous alkylamine solution comprises at least one of monoethanolamine, diethanolamine, or methyldiethanolamine.

Embodiment 4. The system of any one of embodiments 1-3, further comprising a slug catcher configured to receive the natural gas stream and coupled to the amine gas removal unit.

Embodiment 5. The system of any one of embodiments 1-4, further comprising a sulfur recovery unit coupled to the CO₂ permeable membrane and configured to recover sulfur from the H₂S rich stream.

Embodiment 6. The system of any one of embodiments 1-5, further comprising a second compressor coupled to the CO₂ permeable membrane and configured to compress the H₂S rich stream to yield a compressed H₂S rich stream.

Embodiment 7. A method of preventing CO₂ mediated corrosion in a natural gas processing plant, the method comprising:
providing one or more natural gas streams;
removing hydrogen sulfide (H₂S) gas and carbon dioxide (CO₂) gas from the one or more natural gas streams using an acid gas removal unit to yield an acid gas stream that is enriched in H₂S gas and CO₂ gas compared to the one or more natural gas streams:
passing the acid gas stream through a CO₂ permeable membrane to yield a CO₂ rich stream that is enriched in CO₂ compared to the acid gas stream and an H₂S rich stream that is enriched in H₂S compared to the acid gas stream; and
adding a first portion of the H₂S rich stream to the one or more natural gas streams.

Embodiment 8. The method of embodiment 7, wherein removing the H₂S gas and the CO₂ gas from the one or more natural gas streams using an acid gas removal unit comprises:
absorbing the H¬₂S gas and CO₂ gas using an aqueous alkylamine solution to yield a rich amine solution; and
regenerating the aqueous alkylamine solution and the acid gas stream by heating the aqueous alkylamine solution.

Embodiment 9. The method of embodiment 8, wherein the aqueous alkylamine solution comprises at least one of monoethanolamine, diethanolamine, or methyldiethanolamine.

Embodiment 10. The method of any one of embodiments 7-9, further comprising passing the one or more natural gas streams through a slug catcher before removing H₂S gas and CO₂ gas from the one or more natural gas streams.

Embodiment 11. The method of any one of embodiments 7-10, further comprising compressing the acid gas stream before passing the acid gas stream through the CO₂ permeable membrane.

Embodiment 12. The method of any one of embodiments 7-11, further comprising routing a second portion of the H₂S rich stream to a sulfur recovery unit.

Embodiment 13. The method of embodiment 12, further comprising combining the CO₂ rich stream with the second portion of the H¬₂S rich stream to yield a combined stream and routing the combined stream to the sulfur recovery unit.

Embodiment 14. The method of any one of embodiments 7-13, wherein adding a first portion of the H₂S rich stream to the one or more natural gas streams yields a spiked natural gas stream, wherein the spiked natural gas stream comprises a ratio of CO₂ to H₂S from about 20 to about 2.

Embodiment 15. The method of embodiment 14, wherein the spiked natural gas stream comprises a ratio of CO₂ to H₂S from about 5 to about 2.

Embodiment 16. The method of embodiment 15, wherein the spiked natural gas stream comprises a ratio of CO₂ to H₂S of about 2.

A number of implementations of the disclosure have been described. Nevertheless, it will be understood that various modifications may be made without departing from the spirit and scope of the disclosure.

What is claimed is:

1. A system for generating a concentrated H₂S stream from natural gas, the system comprising:
an amine gas removal unit configured to receive a natural gas stream, wherein the amine gas removal unit is further configured to remove hydrogen sulfide gas and carbon dioxide gas from a natural gas stream to yield an acid gas stream;
a first compressor coupled to the amine gas removal unit and configured to compress the acid gas stream to yield a high pressure acid gas stream; and
a CO₂ permeable membrane coupled to the compressor, wherein the CO₂ permeable membrane is configured to separate the high pressure acid gas stream into a CO₂ rich stream that is enriched in CO₂ compared to the high pressure acid gas stream and an H₂S rich stream that is enriched in H₂S compared to the high pressure acid gas stream.

2. The system of claim 1, wherein the amine gas removal unit comprises an aqueous alkylamine solution.

3. The system of claim 2, wherein the aqueous alkylamine solution comprises at least one of monoethanolamine, diethanolamine, or methyldiethanolamine.

4. The system of claim 1, further comprising a slug catcher configured to receive the natural gas stream and coupled to the amine gas removal unit.

5. The system of claim 1, further comprising a sulfur recovery unit coupled to the CO₂ permeable membrane and configured to recover sulfur from the H₂S rich stream.

6. The system of claim 1, further comprising a second compressor coupled to the CO₂ permeable membrane and configured to compress the H₂S rich stream to yield a compressed H₂S rich stream.

7. A method of preventing CO₂ mediated corrosion in a natural gas processing plant, the method comprising:
providing one or more natural gas streams;
removing hydrogen sulfide (H₂S) gas and carbon dioxide (CO₂) gas from the one or more natural gas streams using an acid gas removal unit to yield an acid gas stream that is enriched in H₂S gas and CO₂ gas compared to the one or more natural gas streams;
passing the acid gas stream through a CO₂ permeable membrane to yield a CO₂ rich stream that is enriched in CO₂ compared to the acid gas stream and an H₂S rich stream that is enriched in H₂S compared to the acid gas stream; and
adding a first portion of the H₂S rich stream to the one or more natural gas streams.

8. The method of claim 7, wherein removing the H₂S gas and the CO₂ gas from the one or more natural gas streams using an acid gas removal unit comprises:
absorbing the H₂S gas and CO₂ gas using an aqueous alkylamine solution to yield a rich amine solution; and
regenerating the aqueous alkylamine solution and the acid gas stream by heating the aqueous alkylamine solution.

9. The method of claim 8, wherein the aqueous alkylamine solution comprises at least one of monoethanolamine, diethanolamine, or methyldiethanolamine.

10. The method of claim 7, further comprising passing the one or more natural gas streams through a slug catcher before removing H₂S gas and CO₂ gas from the one or more natural gas streams.

11. The method of claim 7, further comprising compressing the acid gas stream before passing the acid gas stream through the CO₂ permeable membrane.

12. The method of claim 7, further comprising routing a second portion of the H₂S rich stream to a sulfur recovery unit.

13. The method of claim 12, further comprising combining the CO₂ rich stream with the second portion of the H₂S rich stream to yield a combined stream and routing the combined stream to the sulfur recovery unit.

14. The method of claim 7, wherein adding a first portion of the H₂S rich stream to the one or more natural gas streams yields a spiked natural gas stream, wherein the spiked natural gas stream comprises a ratio of CO₂ to H₂S from about 20 to about 2.

15. The method of claim 14, wherein the spiked natural gas stream comprises a ratio of CO₂ to H₂S from about 5 to about 2.

16. The method of claim 15, wherein the spiked natural gas stream comprises a ratio of CO₂ to H₂S of about 2.
